(19) United States
(12) Patent Application Publication
(10) Pub. No.: US 2018/0022851 A1
(43) Pub. Date: Jan. 25, 2018

(54) FLUORINATED COMPOUND, PHOTOCURABLE COMPOSITION, COATING LIQUID, HARD COAT LAYER-FORMING COMPOSITION AND ARTICLE

(71) Applicant: Asahi Glass Company, Limited, Chiyoda-ku (JP)

(72) Inventors: Kiyotaka Takao, Chiyoda-ku (JP); Taiki Hoshino, Chiyoda-ku (JP)

(73) Assignee: Asahi Glass Company, Limited, Chiyoda-ku (JP)

(21) Appl. No.: 15/679,246

(22) Filed: Aug. 17, 2017

Related U.S. Application Data
(63) Continuation of application No. PCT/JP2016/063462, filed on Apr. 28, 2016.

(30) Foreign Application Priority Data
Apr. 30, 2015 (JP) 2015-092928

(51) Int. Cl. C08F 290/06; C09D 151/08; C08G 18/50; C08G 18/79; C08G 18/28

(52) U.S. Cl. CPC C08F 290/067; C08G 18/792; C08G 18/2885; C08G 18/5015; C09D 151/08

(57) ABSTRACT

To provide a fluorinated compound capable of imparting excellent antifouling properties (oily ink repellency and fingerprint-stain removability) and abrasion resistance of the antifouling properties to an object (such as a hard coat layer). It is a reaction product of a compound (a1) having a poly(oxyperfluoroalkylene) chain and one active hydrogen-containing group, a compound (a2) having a poly(oxyperfluoroalkylene) chain and two active hydrogen-containing groups, a compound (b) having a polymerizable carbon-carbon double bond and an active hydrogen-containing group, and a polyisocyanate (c), wherein the proportion of the portion derived from the compound (a1) to the total (100 mass %) of the portion derived from the compound (a1) and the portion derived from the compound (a2) is from 60 to 99.9 mass %.

This application is a continuation of PCT Application No. PCT/JP2016/063462, filed on Apr. 28, 2016, which is based upon and claims the benefit of priority from Japanese Patent Application No. 2015-092928 filed on Apr. 30, 2015. The contents of those applications are incorporated herein by reference in their entireties.

### TECHNICAL FIELD

The present invention relates to a fluorinated compound, a photocurable composition and a coating liquid containing the fluorinated compound, as well as a hard coat layer-forming composition made of the photocurable composition or the coating liquid, and an article having a hard coat layer formed from the composition.

### BACKGROUND ART

Optical articles, displays, optical recording media and the like usually have a hard coat layer for preventing scratches, etc. on their surface.

Further, such articles are desired to have antifouling properties i.e. properties whereby stains (such as fingerprints, sebum, sweat, cosmetics, food, oil ink, etc.) are less likely to adhere to the surface, and even if stains have adhered to the surface, they can be easily removed. For example, if stains adhere to the surface of the spectacle lens, they interfere with good vision and deteriorate visual quality. If stains adhere to the surface of an optical recording medium, a failure in recording or reproduction of signals may occur. If stains adhere to the surface of a display, its visibility deteriorates, and in the case of a touch panel, the operation efficiency tends to be adversely affected.

As a substance capable of imparting antifouling properties to a hard coat layer, a fluorinated compound has been proposed which is obtained by reacting triisocyanate, a perfluoropolyether having one active hydrogen, and a monomer having active hydrogen and a polymerizable carbon-carbon double bond (Patent Document 1).

### PRIOR ART DOCUMENT

### Patent Document

Patent Document 1: Japanese Patent No. 3963169

### DISCLOSURE OF INVENTION

### Technical Problem

However, according to studies conducted by the present inventors, the hard coat layer formed from a composition containing the fluorinated compound described in Patent Document 1, is likely that its antifouling properties tend to be decreased by abrasion. Hereinafter, such a nature that the antifouling properties are less likely to be decreased by abrasion, will be referred to also as “abrasion resistance of the antifouling properties”.

The present invention has an object to provide a fluorinated compound capable of imparting excellent antifouling properties (oily ink repellency, fingerprint stain removability) and abrasion resistance of the antifouling properties to an object (such as a hard coat layer, etc.); a photocurable composition and a coating liquid capable of forming an object excellent in antifouling properties and abrasion resistance of the antifouling properties; a hard coat layer-forming composition capable of forming a hard coat layer excellent in antifouling properties and abrasion resistance of the antifouling properties; and an article having a hard coat layer excellent in antifouling properties and abrasion resistance of the antifouling properties.

### Solution to Problem

The present invention provides a fluorinated compound, a method for producing a fluorinated compound, a photocurable composition, a coating liquid, a hard coat layer-forming composition and an article, having constructions of the following [1] to [13].

[1] A fluorinated compound which is a reaction product of a compound (a1) having a poly(oxyperfluoroalkylene) chain and one active hydrogen-containing group, a compound (a2) having a poly(oxyperfluoroalkylene) chain and two active hydrogen-containing groups, a compound (b) having a polymerizable carbon-carbon double bond and an active hydrogen-containing group, and a polyisocyanate (c), wherein the proportion of the portion derived from the compound (a1) to the total (100 mass %) of the portion derived from the compound (a1) and the portion derived from the compound (a2) is from 60 to 99.9 mass %.
[2] The fluorinated compound according to [1], wherein the number average molecular weight of the compound (a1) is from 1,000 to 6,000, and the number average molecular weight of the compound (a2) is from 1,000 to 6,000.
[3] The fluorinated compound according to [1] or [2], wherein the compound (a1) is a compound represented by the following formula (1), and the compound (a2) is a compound represented by the following formula (2),

D¹-(Cₘ₁F₂ₘ₁O)ₙ₁-E¹ (1)

wherein D¹ is D^{1 1}-R^{f 1}—O—CH₂— or D^{1 2}-O—,

D¹¹ is CF₃— or CF₃—O—,

R^{f1} is a C₁₋₂₀ fluoroalkylene group, a C₂₋₂₀ fluoroalkylene group having an etheric oxygen atom between carbon-carbon atoms, a C₁₋₂₀ alkylene group or a C₂₋₂₀ alkylene group having an etheric oxygen atom between carbon-carbon atoms,

D¹² is a C₁₋₆ perfluoroalkyl group,

m1 is an integer of from 1 to 6,

n1 is an integer of from 2 to 200, (C_{m 1} F_{2m 1} O)_{n 1} may be one composed of at least two types of Cₘ₁F₂ₘ₁O different in m1,

E¹ is a monovalent organic group having one hydroxy group,

E²¹-(Cₘ₂F₂ₘ₂O)ₙ₂-E²² (2)

wherein E²¹ and E²² are each independently a monovalent organic group having one hydroxy group,

m2 is an integer of from 1 to 6,

n2 is an integer of from 2 to 200, and (Cₘ₂F₂ₘ₂O)ₙ₂ may be one composed of at least two types of Cₘ₂F₂ₘ₂O different in m2.

[4] The fluorinated compound according to [3], wherein each of said (C_{m 1} F_{2m 1} O)_{n 1} and said (C_{m 2} F_{2m 2} O)_{n 2} is {(CF₂ O)_{n 1 1} (CF₂ CF₂ O)_{n 1 2}} (wherein n11 is an integer of at least 1, n12 is an integer of at least 1, n11+n12 is an integer of from 2 to 200, and the bonding order of n11 pieces of CF₂O and n12 pieces of CF₂CF₂O is not limited).
[5] The fluorinated compound according to [3] or [4], wherein D^{1 1}-R^{f 1}—O—CH₂— is R^{F 2}—O—CHFCF₂—O—CH₂— (wherein R^{F2} is a C₁₋₆ perfluoroalkyl group terminated with CF₃).
[6] The fluorinated compound according to any one of [3] to [5], wherein the compound (a1) is a compound obtained by converting E²¹ or E²² in the compound (a2) to D¹.
[7] A method for producing a fluorinated compound, characterized by reacting a compound (a1) having a poly(oxyperfluoroalkylene) chain and one active hydrogen-containing group, a compound (a2) having a poly(oxyperfluoroalkylene) chain and two active hydrogen-containing groups, in such an amount that the proportion to the total (100 mass %) with the compound (a1) would be from 0.1 to 40 mass %, a compound (b) having a polymerizable carbon-carbon double bond and an active hydrogen-containing group, in such an amount that the proportion to the total (100 mass %) of the compound (a1) and the compound (a2) would be from 10 to 50 mass %, and a polyisocyanate (c) in such a proportion that any isocyanate group of the polyisocyanate (c) would not remain.
[8] The method according to [7], wherein the isocyanate (c) is reacted to a mixture of the compound (a1) and the compound (a2) to produce a reaction intermediate having isocyanate groups, and then the compound (b) is reacted to the reaction intermediate.
[9] The method according to [8], wherein the compound (a1) is a compound obtained by converting one of the active hydrogen-containing groups of the compound (a2) to a group other than an active hydrogen-containing group, and the mixture of the compound (a1) and the compound (a2) is a mixture of the formed compound (a1) obtained by the conversion and the unconverted compound (a2).
[10] A photocurable composition characterized by comprising the fluorinated compound as defined in any one of [1] to [6], a photopolymerizable compound (excluding the fluorinated compound), and a photopolymerization initiator.
[11] A coating liquid characterized by comprising the photocurable composition as defined in [10], and a solvent.
[12] A hard coat layer-forming composition made of the photocurable composition as defined in [10] or the coating liquid as defined in [11].
[13] An article characterized by comprising a substrate, and a hard coat layer formed from the hard coat layer-forming composition as defined in [12].

### Advantageous Effects of Invention

The fluorinated compound of the present invention is capable of imparting excellent antifouling properties and abrasion resistance of the antifouling properties to an object.

The photocurable composition and the coating liquid of the present invention are capable of forming an object excellent in antifouling properties and abrasion resistance of the antifouling properties.

The hard coat layer-forming composition of the present invention is capable of forming a hard coat layer excellent in antifouling properties and resistance of the antifouling properties.

The article of the present invention has a hard coat layer excellent in antifouling properties and abrasion resistance of the antifouling properties.

### DESCRIPTION OF EMBODIMENTS

In this specification, a compound represented by the formula (1) will be referred to as a compound (1). Compounds represented by other formulae will be referred to in the same manner.

In this specification, a photocurable composition, a coating liquid and a hard coat layer-forming composition may be collectively referred to as a “curable composition”. However, if they contain a solvent, a composition of components other than the solvent may be referred to.

In this specification, meanings of the following terms are as follows.

A “poly(oxyperfluoroalkylene) chain” means a molecular chain having at least two oxyperfluoroalkylene units chained.

An “oxyperfluoroalkylene unit” means a unit having an oxygen atom at one terminal of a perfluoroalkylene group, and its chemical formula shall be presented by placing the oxygen atom to the right hand side of the perfluoroalkylene group.

An “etheric oxygen atom” means an oxygen atom forming an ether bond (—O—) between carbon-carbon atoms.

A “fluoroalkylene group” means a group having some or all of hydrogen atoms in an alkylene group substituted by fluorine atoms, and a “perfluoroalkylene group” means a group having all hydrogen atoms in an alkylene group substituted by fluorine atoms.

A “perfluoroalkyl group” means a group having all of hydrogen atoms in an alkyl group substituted by fluorine atoms.

A “(meth)acryloyl group” is a generic term for an acryloyl group and a methacryloyl group.

A “(meth)acrylate” is a generic term for an acrylate and a methacrylate.

An “object” means one to which antifouling properties are to be imparted. The object may, for example, be a hard coat layer, a liquid-repellent layer, a release layer, a molded product, etc.

### [Fluorinated Compound]

A fluorinated compound of the present invention (hereinafter also referred to as a “fluorinated compound (X)”) is a reaction product of a compound (a1) having a (oxyperfluoroalkylene) chain and one active hydrogen-containing group, a compound (a2) having a poly(oxyperfluoroalkylene) chain and two active hydrogen-containing groups, a compound (b) having a polymerizable carbon-carbon double bond and an active hydrogen-containing group, and a polyisocyanate (c), wherein the proportion of the portion derived from the compound (a1) to the total (100 mass %) of the portion derived from the compound (a1) and the portion derived from the compound (a2) is from 60 to 99.9 mass %.

The fluorinated compound (X) is a reaction product, and the compound (a2) and the polyisocyanate (c) are polyfunctional compounds, and therefore, the fluorinated compound (X) is usually not a single compound, but a mixture of compounds different in the number of portions derived from the above respective reactive compounds.

In the case of obtaining a fluorinated compound (X) by reacting a compound (a1), a compound (a2), a compound (b) and a polyisocyanate (c), depending on the combination of the polyisocyanate (c), and the compound (a1), the compound (a2) and the compound (b), to be reacted therewith, the following fluorinated compounds (X1) to (X4) are considered to be formed.

(X1) a fluorinated compound wherein the compound (a1) and the compound (b) have reacted to the polyisocyanate (c).

(X2) a fluorinated compound wherein only the compound (a1) has reacted to the polyisocyanate (c).

(X3) a fluorinated compound wherein only the compound (b) has reacted to the polyisocyanate (c).

(X4) a cross-linked type fluorinated compound wherein the compound (a2) is linked between at least two polyisocyanates (c) and further either one or both of the compound (a1) and the compound of (b) have reacted to isocyanate groups not contributed to cross-linking, of the respective polyisocyanates (c).

As the fluorinated compound (X1), there will be (the number of isocyanate groups in the polyisocyanate (c)-1) types of fluorinated compounds (X1). For example, when the polyisocyanate (c) has three isocyanate groups, there will be two types of fluorinated compounds i.e. a fluorinated compound wherein two compounds (a1) and one compound (b) have reacted to the polyisocyanate (c), and a fluorinated compound wherein one compound (a1) and two compounds (b) have reacted to the polyisocyanate (C).

Further, as the fluorinated compound (X4), there will be an infinite number of types depending on the numbers of all compounds (a2) and polyisocyanates (c) and the combinations of the compound (a1) and the compound (b) which react to the respective polyisocyanates (c).

For example, in a case where the active hydrogen-containing group is a hydroxy group, and the polyisocyanate (c) is a triisocyanate, as shown by the following formulae, when the compound (a1) with one terminal being a trifluoromethyl group, the compound (a2), the compound (b) and the polyisocyanate (c) are reacted, a mixture of fluorinated compounds (X1) to (X4) can be obtained in which each compound is bonded by a urethane bond.

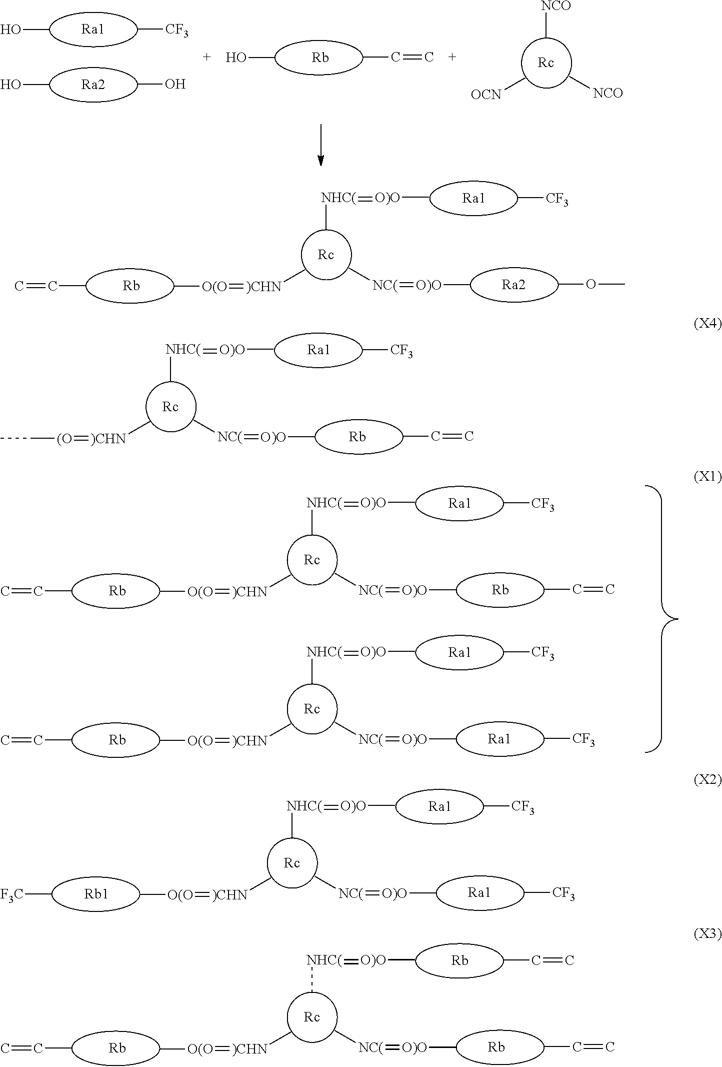

Here, Ra1 is a residue obtained by removing from the compound (a1) the trifluoromethyl group and the hydroxy group at the terminals, Ra2 is a residue obtained by removing from the compound (a2) the hydroxy groups at both terminals, Rb is a residue obtained by removing from the compound (b) the polymerizable carbon-carbon double bond and the hydroxy group at the terminals, and Rc is a residue obtained by removing the isocyanate groups from the polyisocyanate (c). Here, the fluorinated compound (X4) is an example among many types.

### (Poly(Oxyperfluoroalkylene) Chain)

A poly(oxyperfluoroalkylene) chain is a molecular chain wherein at least two oxyperfluoroalkylene units are linked, and one terminal of the poly(oxyperfluoroalkylene) chain is a carbon atom, and the other terminal is an oxygen atom. In this specification, its chemical formula will be given so that the carbon terminal side is at the left therein, the oxygen terminal side is at the right therein.

The compound (a1) and the compound (a2) have poly(oxyperfluoroalkylene) chains. The poly(oxyperfluoroalkylene) chains in the respective compounds may be the same or different. Usually since the compound (a1) and the compound (a2) are produced from a raw material compound having a poly(oxyperfluoroalkylene) chain, a fluorinated compound (X) is produced by using the compound (a1) and the compound (a2) wherein the poly(oxyperfluoroalkylene) chain is the same. Further, also in the case of using the compound (a1) obtained by converting one of the active hydrogen-containing groups in the compound (a2) to a group other than an active hydrogen-containing group, the compound (a1) and the compound (a2) wherein the poly(oxyperfluoroalkylene) chain is the same, will be used.

Poly(oxyperfluoroalkylene) chains impart antifouling properties to an object.

As the poly(oxyperfluoroalkylene) chains, from the viewpoint of sufficiently imparting antifouling properties to an object, chains represented by the following formulae are preferred.

Poly(oxyperfluoroalkylene) chain in the compound (a1): (Cₘ₁F₂ₘ₁O)ₙ₁

Poly(oxyperfluoroalkylene) chain in the compound (a2): (Cₘ₂F₂ₘ₂O)ₙ₂

Here, each of m1 and m2 is an integer of from 1 to 6, each of n1 and n2 is an integer of from 2 to 200, (Cₘ₁F₂ₘ₁O)ₙ₁ may be composed of at least two types of Cₘ₁F₂ₘ₁O different in m1, and (Cₘ₂F₂ₘ₂O)ₙ₂ may be composed of at least two types of Cₘ₂F₂ₘ₂O different in m2.

(Cₘ₁F₂ₘ₁O)ₙ₁ and (Cₘ₂F₂ₘ₂O)ₙ₂ represent the same meaning, and therefore, in the following, the poly(oxyperfluoroalkylene) chain will be described with reference to (Cₘ₁F₂ₘ₁O)ₙ₁ as the representative.

From the viewpoint of sufficiently imparting antifouling properties to an object, m1 is preferably an integer of from 1 to 3, particularly preferably 1 or 2.

When m1 is 2 or more, Cₘ₁F₂ₘ₁ may be linear or branched. From the viewpoint of sufficiently imparting antifouling properties to an object, it is preferably linear.

From the viewpoint of sufficiently imparting antifouling properties to an object, n1 is preferably an integer of at least 3, more preferably an integer of at least 4, particularly preferably an integer of at least 5. From such a viewpoint that if the number average molecular weight of the compound (a1) or the compound (a2) is too large, the number of polymerizable carbon-carbon double bonds present per unit molecular weight of the fluorinated compound (X) decreases, whereby abrasion resistance of the antifouling properties tends to be low, and also from the viewpoint of excellent compatibility between the fluorinated compound (X) and other components in the curable composition, n1 is preferably an integer of at most 100, more preferably an integer of at most 80, particularly preferably an integer of at most 60.

In a case where in (Cₘ₁F₂ₘ₁O)ₙ₁, at least two types of Cₘ₁F₂ₘ₁O different in m1 are present, the bonding order of the respective Cₘ₁F₂ₘ₁O is not limited. For example, in a case where CF₂O and CF₂CF₂O are present, CF₂O and CF₂CF₂O may be randomly or alternatingly arranged, or a block consisting of a plurality of CF₂O and a block consisting of a plurality of CF₂CF₂O may be linked.

From the viewpoint of sufficiently imparting antifouling properties to an object, (Cₘ₁F₂ₘ₁O)ₙ₁ is preferably {(CF₂O)ₙ₁₁(CF₂CF₂O)ₙ₁₂} (wherein n11 is an integer of at least 1, n12 is an integer of at least 1, n11+n12 is an integer of from 2 to 200, and the bonding order of n11 pieces of CF₂O and n12 pieces of CF₂CF₂O is not limited).

{(CF₂O)ₙ₁₁(CF₂CF₂O)ₙ₁₂} is excellent in mobility, whereby an object will be excellent in lubricity. Particularly, (CF₂O)ₙ₁₁ is a group having an oxygen atom with the number of carbon atoms being at least 1 and thus, is superior in mobility.

With respect to {(CF₂O)ₙ₁₁(CF₂CF₂O)ₙ₁₂}, from the viewpoint of efficiency in production of the compound (a1) and the compound (a2), the terminal on the side that binds to —CH₂— of the after-mentioned D, of the {(CF₂O)ₙ₁₁(CF₂CF₂O)ₙ₁₂}, is preferably CF₂O. The {(CF₂O)ₙ₁₁(CF₂CF₂O)ₙ₁₂} wherein the terminal on the side that binds to —CH₂— is CF₂O, will be hereinafter represented by CF₂ O{(CF₂ O)_{n 1 1-1} (CF₂ CF₂ O)_{n 1 2}}. Here, also in CF₂ O{(CF₂ O)_{n 1 1-1} (CF₂ CF₂ O)_{n 1 2}}, as described above, the bonding order of (n11-1) pieces of (CF₂O) and n12 pieces of (CF₂CF₂O) is not limited.

From the viewpoint of sufficiently imparting antifouling properties to an object, n11 is preferably an integer of at least 2, particularly preferably an integer of at least 3. From such a viewpoint that if the number average molecular weight of the compound (a1) is too large, the number of polymerizable carbon-carbon double bonds per unit molecular weight of the fluorinated compound (X) decreases, whereby abrasion resistance of the antifouling properties of an object tends to decrease, and also from the viewpoint of excellent compatibility between the fluorinated compound (X) and other components in the curable composition, n11 is preferably an integer of at most 50, more preferably an integer of at most 40, particularly preferably at most 30.

From the viewpoint of sufficiently imparting antifouling properties to an object, n12 is particularly preferably an integer of at least 2. If the number average molecular weight of the compound (a1) or the compound (a2) is too large, the number of polymerizable carbon-carbon double bonds present per unit molecular weight of the fluorinated compound (X) decreases, whereby abrasion resistance of the antifouling properties of an object tends to decrease, and also from the viewpoint of excellent compatibility between the fluorinated compound (X) and other components in the curable composition, n12 is preferably an integer of at most 50, more preferably an integer of at most 40, particularly preferably an integer of at most 30.

The ratio between n11 and n12, with a view to sufficiently imparting lubricity to an object, is preferably such that n12 is from 1 to 3 times n11.

The compound (a1) or the compound (a2) may be produced as a mixture of plural types of compounds different in number of n1 in (Cₘ₁F₂ₘ₁O)ₙ₁. In such a case, the average value of n1 as a mixture is preferably from 2 to 100, particularly preferably from 4 to 80. Further, the compound (a1) or the compound (a2) may be produced as a mixture of plural types of compounds different in numbers of n11 and n12 in {(CF₂O)ₙ₁₁(CF₂CF₂O)ₙ₁₂}. In such a case, as a mixture, the average value of n11 is preferably from 1 to 50, and the average value of n12 is preferably from 1 to 50.

### (Active Hydrogen-Containing Group)

An active hydrogen-containing group in the compound (a1) or the compound (a2) is one to be reacted with an isocyanate group in the polyisocyanate (c), thereby to let the structure of the compound (a1) or the compound (a2) be incorporated as a part of the structure of the fluorinated compound (X).

The active hydrogen-containing group may, for example, be a hydroxy group, a carboxy group, an amino group, etc. From the viewpoint of availability of raw material, a hydroxy group is particularly preferred.

(Compound (a1))

A compound (a1) is a compound having the above-mentioned poly(oxyperfluoroalkylene) chain and one active hydrogen-containing group. From the viewpoint of sufficiently imparting antifouling properties to an object (such as a hard coat layer), the compound (a1) preferably has a single perfluoroalkyl group.

As the compound (a1), from the viewpoint of sufficiently imparting antifouling properties to an object, a compound (1) represented by the following formula (1) is preferred.

D¹-(Cₘ₁F₂ₘ₁O)ₙ₁-E¹ (1)

wherein D¹ is D¹¹-R^{f1}—O—CH₂— or D¹²-O—,

D¹¹ is CF₃— or CF₃—O—,

R^{f1} is a C₁₋₂₀ fluoroalkylene group, a C₂₋₂₀ fluoroalkylene group having an etheric oxygen atom between carbon-carbon atoms, a C₁₋₂₀ alkylene group, or a C₂₋₂₀ alkylene group having an etheric oxygen atom between carbon-carbon atoms,

D¹² is a C₁₋₆ perfluoroalkyl group,

m1 is an integer of from 1 to 6,

n1 is an integer of from 2 to 200, (Cₘ₁F₂ₘ₁O)ₙ₁ may be composed of at least two types of Cₘ₁F₂ₘ₁O different in m1, and

E¹ is a monovalent organic group having one hydroxy group.

Since D¹¹ is CF₃— or CF₃—O—, one terminal of the compound (1) becomes to be CF₃—. Therefore, the compound (1) is capable of sufficiently imparting antifouling properties to an object.

The number of hydrogen atoms in R^{f1} is preferably at least 1 from the viewpoint of sufficiently imparting lubricity to an object. The number of hydrogen atoms in R^{f1} is (the number of carbon atoms in R^{f1})×2, preferably at most (the number of carbon atoms in R^{f1}) from the viewpoint of sufficiently imparting antifouling properties to an object. From the viewpoint of sufficiently imparting antifouling properties to an object, R^{f1} preferably contains no hydrogen atom.

When R^{f1} has a hydrogen atom, the above-mentioned mobility of (Cₘ₁F₂ₘ₁O)ₙ₁ is further improved, whereby it is possible to sufficiently impart lubricity to an object, and compatibility between the fluorinated compound (X) and other components in the curable composition will be excellent. On the other hand, if R^{f1} does not have a hydrogen atom, it is not possible to sufficiently impart lubricity to an object, and compatibility between the fluorinated compound (X) and other components in the curable composition tends to be insufficient, and storage stability of the curable composition tends to be insufficient.

R^{f1} is, from the viewpoint of efficiency for the production of the compound (1), preferably a group represented by the following formula (g1-1), a group represented by the following formula (g1-2), or a group represented by the following formula (g1-3). Here, R^{F} is the group bonded to D¹¹.

—R^{F}—O—CHFCF₂— (g1-1)

—R^{F}—CHFCF₂— (g1-2)

—R^{F}—C_{z}H_{2z}— (g1-3)

wherein R^{F} is a single bond, a C₁₋₁₅ perfluoroalkylene group or a C₂₋₁₅ perfluoroalkylene group having an etheric oxygen atom between carbon-carbon atoms, and z is an integer of from 1 to 4.

R^{F} is, from the viewpoint of sufficiently imparting antifouling properties to an object, preferably a C₁₋₉ perfluoroalkylene group, or a C₂₋₁₃ perfluoroalkylene group having an etheric oxygen atom between carbon-carbon atoms. The perfluoroalkylene group may be linear or branched.

z is preferably an integer of from 1 to 3. If z is at least 3, C_{z}H_{2z} may be linear or branched, preferably linear.

R^{f1} is, from the viewpoint of efficiency for the production of the compound (1), preferably a group represented by the formula (g1-1), and as the D¹¹-R^{f1}—O—CH₂— group, a group represented by the following formula (g2) is preferred.

R^{F2}—O—CHFCF₂—O—CH₂— (g2)

wherein R^{F2} is a C₁₋₆ perfluoroalkyl group with a terminal being CF₃.

The group represented by the formula (g2) can be formed by adding a perfluoro(alkyl vinyl ether) represented by R^{F2}—O—CF═CF₂, to a poly(oxyperfluoroalkylene) chain-containing compound having HO—CH₂—.

Specific examples of the group represented by the formula (g2) include the following groups.

CF₃ O—CHFCF₂—O—CH₂—,

CF₃ CF₂—O—CHFCF₂—O—CH₂—,

CF₃ CF₂ CF₂—O—CHFCF₂—O—CH₂—,

CF₃ CF₂ CF₂ CF₂—O—CHFCF₂—O—CH₂—,

CF₃ CF₂ CF₂ CF₂ CF₂ CF₂—O—CHFCF₂—O—CH₂—.

The perfluoroalkyl group for D¹² may be linear or branched.

D¹² is, from the viewpoint of sufficiently imparting antifouling properties to an object, preferably a C₁₋₃ perfluoroalkyl group, particularly preferably CF₃— or CF₃CF₂—.

E¹ may be —R¹—OH (wherein R¹ is a divalent organic group which may have fluorine atom(s)).

R¹ is preferably an alkylene group having at most 10 carbon atoms, or a fluoroalkylene group having a most 10 carbon atoms, with the —OH side terminal being a methylene group.

E¹ is preferably —CF₂ CH₂—OH, —CF₂ CF₂ CH₂—OH or —CF₂ CF₂ CF₂ CH₂—OH.

Specific examples of the compound (1) may, for example, be the following.

CF₃CF₂—O—(CF₂CF₂CF₂O)ₙ₁—CF₂CF₂CH₂—OH (11)

CF₃—CF₂CF₂—O—CHFCF₂—O—CH₂—CF₂O{(CF₂O)ₙ₁₁₋₁(CF₂CF₂O)ₙ₁₂}—CF₂CH₂—OH (12)

CF₃—O—{(CF₂O)ₙ₁₁(CF₂CF₂O)ₙ₁₂}—CF₂CH₂—OH (13)

CF₃—O—[(CF₂CF₂O—CF₂CF₂CF₂CF₂O)ₙ₁₃—CF₂CF₂O]—CF₂CF₂CF₂CH₂—OH (14)

CF₃—O—(CF₂CF₂O)ₙ₁—CF₂CH₂—OH (15)

Here, n13×2+1 is an integer of from 3 to 200.

<Number Average Molecular Weight of Compound (a1)>

The number average molecular weight of the compound (a1) is preferably from 1,000 to 6,000, more preferably from 1,000 to 5,000, particularly preferably from 1,200 to 4,000. When the number average molecular weight of the compound (a1) is within such a range, the antifouling properties can be sufficiently imparted to an object, and the compound (a1) will be excellent in compatibility with other components in the curable composition.

The number average molecular weight of the compound (a1) is obtainable by comparison with the flow time of polymethyl methacrylate by gel permeation chromatography (GPC), or by comparing the integral ratio in the terminal functional groups of the internal standard and the compound (a1) by nuclear magnetic resonance apparatus (NMR).

In the production method as described later, in a case where it is difficult to separate the compound (a1), the compound (a2) and the compound (e1), respectively, the number average molecular weight of the mixture of the compound (a1), the compound (a2) and the compound (e1), will be obtained.

(Compound (a2))

A compound (a2) is a compound having the above-mentioned poly(oxyperfluoroalkylene) chain and two active hydrogen-containing groups.

The poly(oxyperfluoroalkylene) chain imparts antifouling properties to an object (such as a hard coat layer).

From the viewpoint of efficiency for the production of the compound (a1) and the compound (a2), the compound (a2) preferably has the same poly(oxyperfluoroalkylene) chain as the poly(oxyperfluoroalkylene) chain of the compound (a1).

As the compound (a2), from the viewpoint of sufficiently imparting antifouling properties to an object, a compound (2) represented by the following formula (2) is preferred.

E²¹-(Cₘ₂F₂ₘ₂O)ₙ₂-E²² (2)

Here, E²¹ and E²² are each independently a monovalent organic group having one hydroxy group,

m2 is an integer of from 1 to 6,

n2 is an integer of from 2 to 200, (Cₘ₂F₂ₘ₂O)ₙ₂ may be one composed of at least two types of Cₘ₂F₂ₘ₂O different in m2.

E²¹ may be HO—R²¹— (wherein R²¹ is a divalent organic group).

R²¹ is preferably an alkylene group having at most 10 carbon atoms.

E²¹ is preferably HO—CH₂—.

E²² may be —R²²—OH (wherein R²² is a divalent organic group which may have fluorine atom(s)).

R²² is preferably an alkylene group having at most 10 carbon atoms, or a fluoroalkylene group having at most 10 carbon atoms, with the —OH side terminal being a methylene group.

E²² is preferably —CF₂ CH₂—OH, —CF₂ CF₂ CH₂—OH or —CF₂ CF₂ CF₂ CH₂—OH.

Specific examples of the compound (2) may, for example, be the following.

HO—CH₂—CF₂CF₂O(CF₂CF₂CF₂O)ₙ₂₋₁—CF₂CF₂CH₂—OH (21)

HO—CH₂—CF₂O{(CF₂O)ₙ₂₁₋₁(CF₂CF₂O)ₙ₂₂}—CF₂CH₂—OH (23)

HO—CH₂—CF₂CF₂CF₂O[(CF₂CF₂O—CF₂CF₂CF₂CF₂O)ₙ₂₃—CF₂CF₂O]—CF₂CF₂CF₂CH₂—OH (24)

HO—CH₂—CF₂O(CF₂CF₂O)ₙ₂₋₁—CF₂CH₂OH (25)

Here, n23×2+2 is an integer of from 4 to 200.

<Number Average Molecular Weight of Compound (a2)>

The number average molecular weight of the compound (a2) is preferably from 1,000 to 6,000, more preferably from 1,000 to 5,000, particularly preferably from 1,200 to 4,000. When the number average molecular weight of the compound (a2) is within such a range, the antifouling properties can be sufficiently imparted to an object, and the compound (a2) will be excellent in compatibility with other components in the curable composition.

The number average molecular weight of the compound (a2) is obtainable in the same manner as in the case of the compound (a1).

(Method for Producing the Compound (a1) and the Compound (a2))

The compound (a1) and the compound (a2) may be respectively separately produced, or may be simultaneously produced from a single starting material. Otherwise, the compound (a1) may be produced from the compound (a2).

As a method of producing the compound (a1) and the compound (a2), in a case the active hydrogen-containing group is a hydroxy group, the following method (1) or method (2) may, for example, be mentioned.

(1) A method of contacting fluorine gas to a compound having a poly(oxyperfluoroalkylene) chain and two carboxy groups, to fluorinate part of carboxy groups, and then reducing the rest of carboxy groups (see JP-A-2011-116947). A commercially available compound may be used as the compound having a poly(oxyperfluoroalkylene) chain and two carboxy groups.

(2) A method of reacting a compound having a poly(oxyperfluoroalkylene) chain and two hydroxy groups, with a perfluoro(alkyl vinyl ether), to add the perfluoro(alkyl vinyl ether) to part of hydroxy groups. A commercially available compound may be used as the compound having a poly(oxyperfluoroalkylene) chain and two hydroxy groups. Commercially available compounds may, for example, be “FLUOROLINK D” (trade name), “Fomblin Z-Dol” (trade name), etc.

Further, it is possible to use the compound (a2) as the compound having two hydroxy groups in the above method (2). In such a case, by letting part of the starting material compound (a2) be left unreacted, it is possible to obtain a mixture of compound (a1) and the compound (a2). Further, by changing the conversion ratio of the compound (a2) to the compound (a1), it is possible to adjust the content ratio of both compounds in the mixture.

<Method (1)>

A specific example of the method (1) will be described as follows.

Compound (53-1) is contacted with fluorine gas to obtain a mixture (x) comprising compound (43-1), unreacted compound (53-1) and compound (33-1).

CF₃—O—{(CF₂O)ₚ(CF₂CF₂O)_{q}}—CF₂C(═O)OH (43-1)

HO—C(═O)—CF₂O{(CF₂O)ₚ(CF₂CF₂O)_{q}}—CF₂C(═O)—OH (53-1)

CF₃—O—{(CF₂O)ₚ(CF₂CF₂O)_{q}}—CF₃ (33-1)

Here, p is an integer of at least 1, q is an integer of at least 0, p+q+1 is an integer of from 3 to 200, and the bonding order of p pieces of CF₂O and q pieces of CF₂CF₂O is not limited.

The mixture (x) is treated with a reducing agent (sodium bis(2-methoxyethoxy) aluminum hydride, etc.) to obtain a mixture comprising compound (13-1), compound (23-1) and unreacted compound (33-1).

CF₃—O—{(CF₂O)ₚ(CF₂CF₂O)_{q}}—CF₂CH₂—OH (13-1)

HO—CH₂—CF₂O{(CF₂O)ₚ(CF₂CF₂O)_{q}}—CF₂CH₂—OH (23-1)

CF₃—O—{(CF₂O)ₚ(CF₂CF₂O)_{q}}—CF₃ (33-1)

<Method (2)>

A specific example of the method (2) will be described as follows.

Compound (23-1) and perfluoro(n-propyl vinyl ether) (CF₃CF₂CF₂—O—CF═CF₂) are reacted to obtain a mixture comprising compound (12-1), unreacted compound (23-1) and compound (32-1).

CF₃—CF₂CF₂—O—CHFCF₂—O—CH₂—CF₂O{(CF₂O)ₚ(CF₂CF₂O)_{q}}—CF₂CH₂—OH (12-1)

HO—CH₂—CF₂O{(CF₂O)ₚ(CF₂CF₂O)_{q}}—CF₂CH₂—OH (23-1)

CF₃—CF₂CF₂—O—CHFCF₂—O—CH₂—CF₂O{(CF₂O)ₚ(CF₂CF₂O)_{q}}—CF₂CH₂—O—CF₂CHF—O—CF₂CF₂—CF₃ (32-1)

<By-Products>

In the method (1) and method (2), a compound (e1) having a poly(oxyperfluoroalkylene) chain and two perfluoroalkyl groups and not having an active hydrogen atom may be produced as a by-product.

The compound (e1) may be included in the mixture comprising the compound (a1) and the compound (a2) obtained by the method (1) or method (2), may be included in the fluorinated compound (X) prepared by using the mixture comprising the compound (a1) and the compound (a2), may be included in a curable composition prepared by using the fluorinated compound (X), or may be included in a hard coat layer formed from a hard coat layer-forming composition. However, the compound (e1) has low compatibility with other components, and therefore, if the compound (e1) remains in the curable composition, the curable composition becomes cloudy. When the mixture obtained by the method (1) or method (2) contains the compound (e1), the compound (e1) may be removed by purification.

Specific examples of the compound (e1) may, for example, be the following.

CF₃CF₂—O—(CF₂C F₂C F₂O)ₙ₃—CF₂CF₃ (31)

CF₃—CF₂CF₂—O—CHFCF₂—O—CH₂—CF₂O{(CF₂O)ₙ₃₁₋₁(CF₂CF₂O)ₙ₃₂}—CF₂H₂—O—CF₂CHF—O—CF₂CF₂—CF₃ (32)

CF₃—O—{(CF₂O)ₙ₃₁(CF₂CF₂O)ₙ₃₂}—CF₃ (33)

CF₃—O—(CF₂CF₂O)ₙ₃—CF₃ (35)

Here, n3 is an integer of from 2 to 200, n31 is an integer of at least 1, n32 is an integer of at least 0, n31+n32 is an integer of from 2 to 200, and the bonding order of n31 pieces of CF₂O and n32 pieces of CF₂CF₂O is not limited.

### (Compound (b))

Compound (b) is a compound having a polymerizable carbon-carbon double bond and an active hydrogen-containing group.

The polymerizable carbon-carbon double bond reacts, by light irradiation, with a photopolymerizable compound as described later, included in the curable composition, to impart abrasion resistance to an object (such as a hard coat layer, etc.).

A group having the polymerizable carbon-carbon double bond may, for example, be a (meth)acryloyl group, a vinyl group, an allyl group, a styryl group, a maleimide group, etc. From the viewpoint of sufficiently imparting abrasion resistance to an object, a (meth)acryloyl group is preferred, and an acryloyl group is particularly preferred.

The number of polymerizable carbon-carbon double bonds per molecule of the compound (b), is preferably from 1 to 8, more preferably from 1 to 4, particularly preferably 1.

The number of active hydrogen-containing groups per molecule of the compound (b), is preferably 1. The active hydrogen-containing group is preferably a hydroxy group.

The compound (b) may, for example, be a hydroxyalkyl (meth)acrylate, a polyoxyalkylene glycol mono(meth)acrylate, etc. As the compound (b), a hydroxyalkyl (meth)acrylate having a carbon number of the hydroxyalkyl group being from 2 to 10 is preferred, and a hydroxyalkyl acrylate having a linear hydroxyalkyl group having a hydroxy group at the terminal is particularly preferred.

Specific examples of the compound (b) may, for example, be the following.

HOCH₂ CH₂ OC(═O)C(R)═CH₂,

H₂ NCH₂ CH₂ OC(═O)C(R)═CH₂,

HO(CH₂ CH₂ O)ᵢ—C(═O)C(R)C═CH₂,

CH₃ CH(OH)CH₂ OC(═O)C(R)C═CH₂,

CH₃ CH₂ CH(OH)CH₂ OC(═O)C(R)C═CH₂,

C₆ H₅ OCH₂ CH(OH)CH₂ OC(═O)C(R)C═CH₂,

HOCH₂CH═CH₂,

HO(CH₂)ₖCH═CH₂,

(CH₃)₃SiCH(OH)CH═CH₂,

HOC₆ H₄ CH═CHC₆ H₅.

Here, R is a hydrogen atom or a methyl group, i is an integer from 2 to 10, and k is an integer of from 2 to 20.

### (Polyisocyanate (c))

A polyisocyanate (c) is a compound having at least two isocyanate groups.

Such isocyanate groups are ones to react with an active hydrogen-containing group of the compound (a1), an active hydrogen-containing group of the compound (a2) and an active hydrogen-containing group of the compound (b), to introduce the structure of the polyisocyanate (c) as part of the structure of the fluorinated compound (X).

The number of isocyanate groups is preferably from 2 to 4, particularly preferably 3.

The polyisocyanate (c) may, for example, be a diisocyanate such as hexamethylene diisocyanate, isophorone diisocyanate, 4,4′-dicyclohexylmethane diisocyanate, tolylene diisocyanate, 4,4′-diphenylmethane diisocyanate or xylylene diisocyanate, and a modified diisocyanate such as a triisocyanate or tetraisocyanate.

As the diisocyanate, a non-yellowing diisocyanate (i.e. a diisocyanate having no isocyanate group directly bonded to an aromatic nucleus) is preferred, and an alkylene diisocyanate or alicyclic diisocyanate is preferred.

The modified product of diisocyanate may, for example, be an isocyanurate-modified product, a biuret-modified product, or a polyhydric alcohol-modified product, such as one modified by a trihydric or tetrahydric alcohol. The trihydric or tetrahydric alcohol may, for example, be glycerin, trimethylolpropane, pentaerythritol, etc.

Specific examples of triisocyanate may, for example, be the following.

An isocyanurate-modified alkylene diisocyanate (cyclic trimer of alkylene diisocyanate) represented by the following formula (6-1),

An isocyanurate-modified tolylene diisocyanate (cyclic trimer of tolylene diisocyanate) represented by the following formula (6-2),

An isocyanurate-modified isophorone diisocyanate (cyclic trimer of isophorone diisocyanate) represented by the following formula (6-3),

A biuret modified alkylene diisocyanate represented by the following formula (6-4),

A glycerol-modified alkylene diisocyanate represented by the following formula (6-5).

Here, s, t and u are each independently an integer of from 2 to 10.

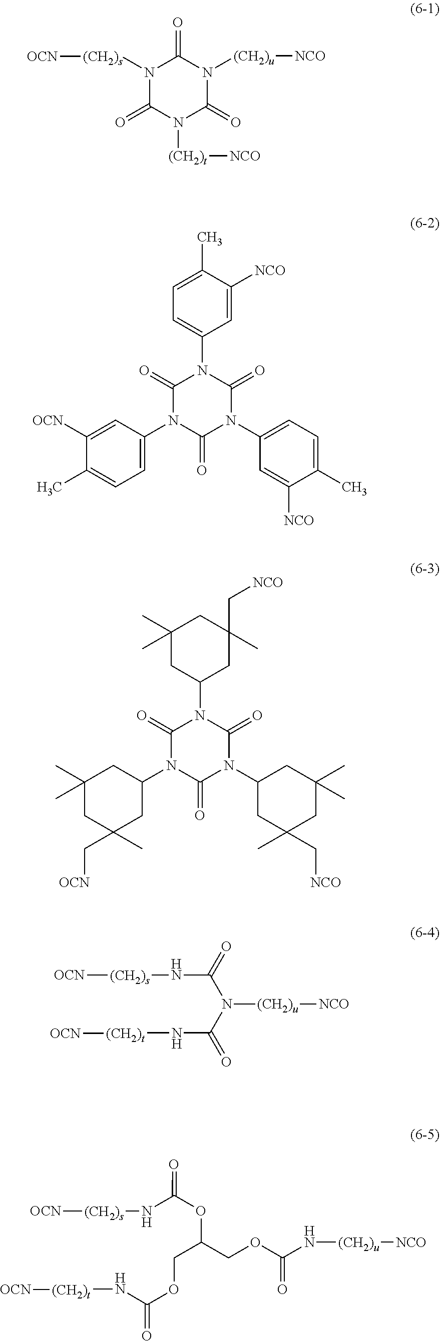

### (Method for Producing Fluorinated Compound (X))

A fluorinated compound (X) is produced by reacting, in the presence of a urethane catalyst, to a polyisocyanate (c), compounds having active hydrogen-containing groups (a compound (a1), a compound (a2) and a compound (b)) simultaneously, or to a polyisocyanate (c), a compound (a1) and a compound (a2), and a compound (b) sequentially.

The equivalent ratio of the polyisocyanate (c) to the total equivalents of the compounds having active hydrogen-containing groups, is theoretically 1:1, but in order not to let isocyanate groups unreacted to the compound (X) be left, it is usually preferred to use the compounds having active hydrogen-containing groups excessively by from 1.01 to 1.5 equivalent times.

As the reaction products to be formed by the above reaction, usually, by-products will also be produced in addition to the fluorinated compound (X). Further, an unreacted compound having an active hydrogen-containing group may also remain. For example, if unreacted compound (a1) and compound (a2) remain, also in the finally obtainable curable composition, the compound (a1) and the compound (a2) will remain. A compound (a1) and a compound (a2) are poor in compatibility with other components, and, if the compound (a1) and the compound (a2) remain in the curable composition, the curable composition becomes cloudy.

Therefore, at the time of using the compounds having active hydrogen-containing groups excessively, it is preferred that first, the compound (a1) and the compound (a2) are reacted with an excess equivalent amount of the polyisocyanate (c), to let all active hydrogen groups in the compound (a1) and the compound (a2) be reacted with isocyanate groups, and to the remaining isocyanate groups, at least an equivalent amount of the compound (b) is reacted.

The mass ratio of the compound (b) to the total of the compound (a1) and the compound (a2), may suitably be set depending on the properties (antifouling properties, abrasion resistance, etc.) required for an object (such as a hard coat layer). From a balance between antifouling properties and abrasion resistance to be imparted to an object, the proportion of the compound (b) to the total (100 mass %) of the compound (a1) and the compound (a2) is preferably from 10 to 50 mass %, particularly preferably from 20 to 40 mass %.

In the total (100 mass %) of the portion derived from the compound (a1) and the portion derived from the compound (a2) in the fluorinated compound (X), the proportion of the portion derived from the compound (a1) is from 60 to 99.9 mass %. Thus, the proportion of the portion derived from the compound (a2) is from 0.1 to 40 mass %. When the proportion of the portion derived from the compound (a1) is at least the lower limit value in the above range, it is possible to impart antifouling properties to an object. Further, compatibility between the fluorinated compound (X) and other components will be also excellent. When the proportion of the portion derived from the compound (a1) is at most the upper limit value in the above range, it is possible to impart abrasion resistance of the antifouling properties to an object.

Therefore, in the production of the fluorinated compound (X), in order to bring the proportions of the portion derived from the compound (a1) and the portion derived from the compound (a2) to the above-mentioned proportions, the proportion of the compound (a1) in the total (100 mass %) of the compound (a1) and the compound (a2) is preferably from 60 to 99.9%, more preferably from 70 to 99 mass %, particularly preferably from 80 to 95 mass %.

The proportion of compound (a2) in the total (100 mass %) of the compound (a1) and the compound (a2) is from 0.1 to 40 mass %, preferably from 1 to 30 mass %, particularly preferably from 5 to 20 mass %. When the proportion of the compound (a2) is at least the lower limit value in the above range, it is possible to impart abrasion resistance of the antifouling properties to an object. When the proportion of the compound (a2) is at most the upper limit value in the above range, it is possible to impart antifouling properties to an object. Further, compatibility between the fluorinated compound (X) and other components will be excellent.

The urethanization catalyst may, for example, be cobalt naphthenate, zinc naphthenate, zinc 2-ethylhexanoate, dibutyltin dilaurate, tin 2-ethylhexanoate, triethylamine, 1,4-diazabicyclo[2.2.2] octane, etc.

At the time of producing the fluorinated compound (X), additives necessary for the production (hereinafter also referred to as “production additives”) may also be used. The production additives may, for example, be polymerization inhibitors, etc.

The reaction of the compounds having active hydrogen-containing groups and the polyisocyanate (c) is preferably carried out in an organic solvent.

The organic solvent may be a fluorinated organic solvent or may be a non-fluorinated solvent, or both solvents may be used in combination. From such a viewpoint that the respective raw materials and the fluorinated compound (X) may be easily dissolved, as the fluorinated organic solvent, for example, a fluoroalkane, a chlorofluoroalkane, a fluoro aromatic compound or a fluoroalkyl ether is preferred, and a chlorofluoroalkane or a fluoroalkyl ether is more preferred, and as the non-fluorinated solvent, a glycol ether-type organic solvent or a ketone-type organic solvent is preferred.

### (Number Average Molecular Weight of Fluorinated Compound (X))

The number average molecular weight of the fluorinated compound (X) is preferably from 1,200 to 8,000, more preferably from 1,200 to 7,000, particularly preferably from 1,200 to 5,000. When the number average molecular weight is within such a range, it is possible to sufficiently impart antifouling properties and abrasion resistance of the antifouling properties to an object (such as a hard coat layer), and compatibility between the fluorinated compound and other components will be excellent in the curable composition.

The number average molecular weight of the fluorinated compound is a number average molecular weight calculated as polymethylmethacrylate obtained by gel permeation chromatography (GPC).

### (Advantageous Effects)

In the fluorinated compound (X) of the present invention as described above, the proportion of the portion derived from the compound (a1) in the total of the portion derived from the compound (a1) and the portion derived from the compound (a2) is at least 60 mass %, and therefore, the surface energy of the surface of an object (such as a hard coat layer) will be lowered by the structure (particularly by the terminal CF₃—) of the portion derived from the compound (a1). As a result, it is possible to impart antifouling properties to the object.

Further, since the proportion of the portion derived from the compound (a2) in the total of the portion derived from the compound (a1) and the portion derived from the compound (a2) is at least 0.1 mass %, the structure of the portion derived from the compound (a2) will be sufficiently introduced into the fluorinated compound. Therefore, the fluorinated compound (X) tends to have a high molecular weight, whereby the fluorinated compound (X) will be firmly fixed to a cured film (such as a hard coat layer) formed from a curable composition containing the fluorinated compound (X). As a result, it is possible to impart abrasion resistance of the antifouling properties to an object.

Further, since the proportion of the compound (a2) in the total of the compound (a1) and the compound (a2) is at most 40 mass %, the molecular weight of the fluorinated compound (X) will not be too large. As a result, compatibility between the fluorinated compound (X) and other components will also be excellent.

### [Photocurable Composition]

A photocurable composition of the present invention comprises the fluorinated compound (X), a photopolymerizable compound (excluding the fluorinated compound (X)) and a photopolymerization initiator. The photocurable composition of the present invention may further contain additives for the photocurable composition as the case requires.

### (Photopolymerizable Compound)

The photopolymerizable compound is a monomer to initiate a polymerization reaction by irradiation with light in the presence of a later-described photopolymerization initiator.

As the photopolymerizable compound, a polyfunctional monomer or a monofunctional monomer may be mentioned. From the viewpoint of imparting abrasion resistance to an object (such as a hard coat layer, etc.), one containing a polyfunctional monomer as an essential component is preferred.

As the photopolymerizable compound, one type may be used alone, or two or more types may be used in combination.

The polyfunctional monomer may be a compound having at least two (meth)acryloyl groups in one molecule. The number of (meth)acryloyl groups per molecule of the polyfunctional monomer, is preferably 3, particularly preferably from 3 to 30.

The polyfunctional monomer is, from the viewpoint of imparting sufficient abrasion resistance to an object, a monomer having at least three (meth)acryloyl groups, wherein the molecular weight per one (meth)acryloyl group is at most 120, or a monomer having a urethane bond and at least three (meth)acryloyl groups.

The polyfunctional monomer may, for example, be a poly(meth)acrylate of a polyol (such as trimethylolpropane, glycerol, pentaerythritol, multimers thereof, etc.), tris(2-acryloyloxyethyl) isocyanurate, a reaction product of a polyol, a polyisocyanate and a hydroxyalkyl (meth)acrylate, or a reaction product of a monofunctional monomer having a hydroxy group and a polyisocyanate.

### (Photopolymerization Initiator)

The photopolymerization initiator may be a known photopolymerization initiator including, for example, aryl ketone photopolymerization initiators (acetophenones, benzophenones, alkylamino benzophenones, benzyls, benzoins, benzoin ethers, benzyl dimethyl ketals, benzoyl benzoates, α-acyl oxime esters, etc.), sulfur-containing photopolymerization initiators (sulfides, thioxanthones, etc.), acyl phosphine oxides (acyl diaryl phosphine oxide, etc.), other optical polymerization initiators.

As the photopolymerization initiator, one type may be used alone, or two or more types may be used in combination.

The photopolymerization initiator may be used in combination with a photosensitizer such as an amine.

### (Additives for Photocurable Composition)

The additives for the photocurable composition may, for example, be colloidal silica, photosensitizers, UV absorbers, light stabilizers, heat curing stabilizers, antioxidants, leveling agents, anti-foams, thickeners, anti-settling agents, pigments, dyes, dispersing agents, antistatic agents, surfactants (anti-fogging agent, a leveling agent, etc.), metal oxide particles, various resins (epoxy resin, unsaturated polyester resin, polyurethane resin, etc.), etc.

### (Composition of Photocurable Composition)

The content of the fluorinated compound (solvent) is preferably from 0.01 to 5 mass %, more preferably from 0.02 to 4 mass %, particularly preferably from 0.05 to 3 mass %, in the photocurable composition (excluding the solvent) (100 mass %). When the content of the fluorinated compound (X) is within the above range, the storage stability of the photocurable composition, and the appearance, wear resistance, antifouling properties and abrasion resistance of the antifouling properties of an object (such as a hard coat layer) will be excellent.

The content of the photopolymerizable compound is preferably from 20 to 98.99 mass %, more preferably from 50 to 98.99 mass %, further preferably from 60 to 98.99 mass %, particularly preferably from 80 to 98.99 mass %, in the photocurable composition (excluding the solvent) (100 mass %). When the content of the photopolymerizable compound is within the above range, the storage stability of the photocurable composition, and the appearance, wear resistance, antifouling properties and abrasion resistance of the antifouling properties of an object will be excellent.

The content of the photopolymerization initiator is preferably from 1 to 15 mass %, more preferably from 3 to 15 mass %, particularly preferably from 3 to 10 mass %, in the photocurable composition (excluding the solvent) (100 mass %). When the content of the photopolymerization initiator is within the above range, compatibility with the photopolymerizable compound will be excellent. Further, curability of the photocurable composition will be excellent and a cured film to be formed will be excellent in hardness.

In a case where additives for the photocurable composition are to be incorporated, the content of the additives for the photocurable composition is preferably from 0.5 to 20 mass %, more preferably from 1 to 15 mass %, particularly preferably from 1 to 10 mass % in the photocurable composition (excluding the solvent) (100 mass %).

The photocurable composition of the present invention may contain impurities such as a by-product (such as compound (e1)) formed in the production of the fluorinated compound (X), unreacted starting materials (such as compound (a1), compound (a2), compound (b), polyisocyanate (c), etc.), production additives (such as a polymerization inhibitor, etc.) used in the preparation of the fluorinated compound (X), etc.

Among the impurities, the compound (a1), the compound (a2) and the compound (e1) are poor in compatibility with other components, and therefore, if the compound (a1), the compound (a2) and the compound (e1) remain in the curable composition, the curable composition becomes cloudy. Therefore, the total content of the compound (a1), the compound (a2) and the compound (e1) is preferably at most 10 mass %, particularly at most 5 mass %, to the fluorinated compound (X) (100 mass %).

Among impurities, the polyisocyanate (c) has a high reactivity with other components, and if the polyisocyanate (c) remains in the curable composition, the storage stability of the curable composition will be lowered. Therefore, the content of the polyisocyanate (c) is preferably at most 4 mass %, particularly preferably at most 1 mass %, to the fluorinated compound (X) (100 mass %).

Identification and quantification of the impurities are carried out by ¹H-NMR and ¹⁹F-NMR or gas chromatography.

### [Coating Liquid]

The coating liquid of the present invention comprises the photocurable composition of the present invention and a solvent.

The coating liquid of the present invention is prepared in order to make the photocurable composition of the present invention easily applicable to a substrate.

### (Solvent)

As the solvent, an organic solvent is preferred. As the organic solvent, an organic solvent having a boiling point suitable for the application method is preferred.

The organic solvent may be a fluorinated organic solvent or a non-fluorinated organic solvent, or both solvents may be used in combination.

The fluorinated organic solvent may, for example, be a fluoroalkane, a fluoro aromatic compound, a fluoroalkyl ether, a fluoroalkyl amine, a fluoroalkyl alcohol, etc.

The fluorinated organic solvent is, from such a viewpoint that the fluorinated compound (X) is easily dissolved, preferably a fluoroalkane, a fluoro aromatic compound, a fluoroalcohol or a fluoroalkyl ether, particularly preferably a fluoroalcohol or a fluoroalkyl ether.

As the non-fluorinated organic solvent, a compound consisting of hydrogen atoms and carbon atoms, or a compound consisting of hydrogen atoms, carbon atoms and oxygen atoms is preferred, and a hydrocarbon-type organic solvent, an alcohol-type organic solvent, a ketone-type organic solvent, an ether-type organic solvent, a glycol ether-type organic solvent, an ester organic solvent, etc. may be mentioned.

The non-fluorinated organic solvent is, from such a viewpoint that the fluorinated compound (X) can be readily dissolved therein, particularly preferably a glycol ether-type organic solvent or a ketone-type organic solvent.

As the solvent, preferred is at least one organic solvent selected from the group consisting of fluoroalkanes, fluoro aromatic compounds, fluoroalkyl ethers, fluoroalcohols, compounds consisting solely of hydrogen and carbon atoms, and compounds consisting solely of hydrogen atoms, carbon atoms and oxygen atoms, and particularly preferred is a fluorinated organic solvent selected from fluoroalkanes, fluoro aromatic compounds, fluoroalkyl ethers and fluoroalcohols.

As the solvent, from the viewpoint of increasing the solubility of the fluorinated compound (X), preferred is one in which at least one organic solvent selected from the group consisting of fluoroalkanes, fluoro aromatic compounds, fluoroalkyl ethers, fluoroalcohol, and compounds consisting solely of hydrogen atoms, carbon atoms and oxygen atoms, is contained in an amount in total of at least 90 mass % of the entire solvent.

The content of the solvent is preferably from 5 to 80 mass %, more preferably from 10 to 70 mass %, particularly preferably from 20 to 60 mass %, in the coating liquid (100 mass %).

### [Hard Coat Layer-Forming Composition]

A hard coat layer-forming composition of the present invention is made of the photocurable composition of the present invention or the coating liquid of the present invention.

The photocurable composition and the coating liquid of the present invention require no heating at the time of curing coating films formed therefrom, and therefore, they are preferably used at the time of forming a hard coat layer on a substrate made of a resin having a low heat resistance as compared with e.g. glass.

### (Advantageous Effects)

The photocurable composition, coating liquid and hard coat layer-forming composition of the present invention as described above, contain the fluorinated compound (X) and thus, they are capable of forming an object (such as a hard coat layer) excellent in antifouling properties and abrasion resistance of the antifouling properties.

### [Article]

An article of the present invention comprises a substrate and a hard coat layer formed from the hard coat layer-forming composition of the present invention.

### (Hard Coat Layer)

The hard coat layer may be formed directly on at least one surface of the substrate, or may be formed via a primer layer as described below on at least one surface of the substrate.

The thickness of the hard coat layer is, from the viewpoint of abrasion resistance and antifouling properties, preferably from 0.5 to 20 μm, particularly preferably from 1 to 15 μm.

### (Substrate)

The substrate is a member to constitute the main body portion of a various article (such as an optical lens, a display, an optical recording medium, etc.) required to have abrasion resistance and antifouling properties or to constitute the surface of such an article.

As the material for the surface of the substrate, a metal, resin, glass, ceramics, stone, a composite material thereof, etc. may be mentioned. As the material for the substrate in an optical lens, a display or an optical recording medium, a glass or transparent resin substrate material is preferred.

### (Primer Layer)

The article of the present invention may further have a primer layer between the substrate and the hard coat layer with a view to improving the adhesion between the substrate and the hard coat layer.

The primer layer may be a known one. The primer layer may be formed, for example, by applying a primer layer-forming composition containing a solvent on the surface of a substrate, and removing the solvent by evaporation.

### (Applications of the Article)

The article of the present invention is suitable as a member to constitute a touch panel. The touch panel is an input device for an input/display device (touch panel device) having a display device and a device for inputting a contact position information by contact with a finger or the like combined. The touch panel is composed of a substrate, an input detecting means, etc. The input detecting means is composed of, for example, a transparent conductive film, electrodes, wirings, IC, etc. By using the surface having the hard coat layer of the article as the input surface of a touch panel, it is possible to obtain a touch panel excellent in antifouling properties and abrasion resistance of the antifouling properties.

### (Method of Producing Article)

The article may be produced, for example, via the following step (I) and step (II).

Step (I): A step of forming a primer layer by applying a primer layer-forming composition on the surface of a substrate, as the case requires.

Step (II): A step of forming a hard coat layer by applying a hard coat layer-form ing composition on the surface of the substrate or the primer layer to obtain a coating film, then, in a case where the hard coat layer-forming composition contains a solvent, removing the solvent, followed by photocuring.

### (Advantageous Effects)

The article of the present invention as described above, has a hard coat layer formed from the hard coat layer-forming composition, and thus is excellent in antifouling properties and abrasion resistance of the antifouling properties.

### EXAMPLES

In the following, Examples according to the present invention and Comparative Examples will be described. However, the present invention is not limited only to such Examples.

Ex. 2, 3, 6, 8 and 9 are Examples of the present invention, and Ex. 1, 4, 5, 7, 10 and 11 are Comparative Examples.

### [Abbreviations]

AC-2000: C₆F₁₃H (ASAHIKLIN (registered trademark) AC-2000, manufactured by Asahi Glass Company, Limited),

AE-3000: CF₃CH₂OCF₂CF₂H (ASAHIKLIN (registered trademark) AE-3000, manufactured by Asahi Glass Company, Limited),

AK-225: mixture of CF₃CF₂CHCl₂ and CCIF₂CF₂CHCIF (ASAHIKLIN (registered trademark) AK-225, manufactured by Asahi Glass Company, Limited),

DBTDL: dibutyltin dilaurate,

L: liters,

Mn: number-average molecular weight.

### [Measurements and Evaluations]

(Mn of Compound (a1), Compound (a2) and Compound (e1))

The number-average molecular weights of the compound (a1), the compound (a2) and the compound (e1) were obtained by comparing the integration ratios of terminal functional groups of the internal standard substance and the compound (a1), compound (a2) and compound (e1), respectively, by a nuclear magnetic resonance apparatus (NMR).

### (Mn of Fluorinated Compound)

By measuring GPC of several types of monodisperse polymethyl methacrylate different in polymerization degree, which are commercially available as standard samples for measuring of molecular weights, by a GPC measurement apparatus (HLC-8220GPC, manufactured by Tosoh Corporation), using as an eluent a mixed solvent of AK-225:hexafluoroisopropanol=99:1 (volume ratio), a calibration curve was prepared based on the relationship between the molecular weight and the retention time of the polymethyl methacrylate.

A fluorinated compound was diluted to 1.0 mass % with the mixed solvent, and then passed through the 0.5 μm filter, whereupon the GPC for the fluorinated compound was measured by using the GPC measurement apparatus.

Using the calibration curve, Mn of the fluorinated compound was obtained by subjecting the GPC spectrum of the fluorinated compound to computer analysis.

### (Compatibility)

In accordance with the following standards, the appearance of a hard coat layer-forming composition immediately after the preparation was visually evaluated.

◯ (good): The solution is uniform and no turbidity is observed.

x (bad): Turbidity is observed.

### (Storage Stability)

A hard coat layer-forming composition was left to stand still at room temperature for 3 months, whereupon the appearance of the hard coat layer-forming composition was visually evaluated.

◯ (good): The solution is uniform, and no turbidity is observed.

x (bad): Turbidity is observed.

### (Appearance of Hard Coat Layer)

In accordance with the following standards, the appearance of a hard coat layer was visually evaluated.

◯ (good): No foreign matter is observed, and the film thickness is uniform.

Δ (acceptable): Although no foreign matter is observed, there is unevenness in the film thickness.

x (bad): A foreign matter is observed, and there is unevenness in the film thickness.

### (Fingerprint Stain Removability)

An artificial fingerprint liquid (a liquid consisting of oleic acid and squalene) was deposited on a flat surface of a silicon rubber plug, and an excessive oil was wiped off by a nonwoven fabric (BEMCOT (registered trademark) M-3, manufactured by Asahi Kasei Corporation), to prepare a fingerprint stamp. The fingerprint stamp was placed on an article having a hard coat layer and pressed for 10 seconds under a load of 9.8 N. The portion where the fingerprint was adhered, was wiped off by using a reciprocating traverse testing machine (KNT Co.) having a tissue paper attached thereon, under a load of 4.9 N. By observing the haze visually after every reciprocation for wiping, the haze was evaluated by observing it visually until after 10 reciprocations. The evaluation standards are as follows.

◯ (good): No haze is visually observed.

Δ (acceptable): The haze is slightly visually observed.

x (poor): The haze is clearly visually observed.

### (Oily Ink Repellency)

It was evaluated by drawing a line by a felt pen (McKee thick black, manufactured by Zebra Co. Ltd.) on the surface of a coating layer and visually observing the state of adhesion of oily ink. The evaluation standards are as follows.

⊚ (excellent): Oily ink is repelled in a ball shape.

◯ (good): Oily ink is not repelled in a ball shape, but repelled in a linear line, whereby the line width is less than 50% of the pen tip width of the felt pen.

Δ (acceptable): Oily ink is not repelled in a ball shape, but repelled in a linear line, whereby the linear line width is at least 50% and less than 100% of the pen tip width of the felt pen.

x (bad): Oily ink is not repelled in a ball shape or in a linear line, and a clean line can be drawn on the surface.

### (Abrasion Resistance of Antifouling Properties)

With respect to an article having a hard coat layer, using a reciprocating traverse testing machine (manufactured by KNT Co.), steel wool (Bonstar (registered trademark) #0000, manufactured by Nippon Steel Wool Co.) was reciprocated 500 times under a load of 9.8N, and a line was drawn on the surface of the hard coat layer by a felt pen (McKee thick black, manufactured by Zebra Co. Ltd.), whereupon it was evaluated by observing the adhesion state of oily ink visually. The evaluation standards are the same as in the above “Oily ink repellency”.

### (Pencil Hardness)

The pencil hardness of the surface of a hard coat layer was measured in accordance with JIS K5600-5-4: 1999 (ISO 15184: 1996) “Scratch hardness (pencil method)”.

[Production of Compound (a1) and Compound (a2)]

### (Production of Compound (13-1-1) and Compound (23-1-1))

Following the method disclosed in JP2011-116947, paragraphs [0061] and [0062], from compound (53-1-1) (FLUOROLINK (registered trademark) C, manufactured by Solvay Solexis Inc.), a mixture comprising compound (13-1-1), compound (23-1-1) and compound (33-1-1) was obtained.

HO—C(═O)—CF₂O{(CF₂O)ₚ(CF₂CF₂O)_{q}}—CF₂C(═O)—OH (53-1-1)

CF₃—O—{(CF₂O)ₚ(CF₂CF₂O)_{q}}—CF₂CH₂—OH (13-1-1)

HO—CH₂—CF₂O{(CF₂O)ₚ(CF₂CF₂O)_{q}}—CF₂CH₂—OH (23-1-1)

CF₃—O—{(CF₂O)ₚ(CF₂CF₂O)_{q}}—CF₃ (33-1-1)

Here, p/q=0.6, and p+q≈15.

The mixture was developed by silica gel column chromatography (developing solvents: AC-2000 and AE-3000) to fractionate the desired compounds. After the fractionation, the compound (13-1-1), the compound (23-1-1) and the compound (33-1-1) were mixed so that the mass ratio would be as shown in Table 1 to obtain the mixtures (p1-1) to (p1-6).

Mn of the compound (13-1-1) was 1,540, Mn of the compound (23-1-1) was 1,570, and Mn of the compound (33-1-1) was 1,540.

TABLE 1

| | | Mixture [mass ratio] | | | | | |
|---|---|---|---|---|---|---|---|
| | | (p1-1) | (p1-2) | (p1-3) | (p1-4) | (p1-5) | (p1-6) |
| (a1) | (13-1-1) | 100 | 90 | 70 | 30 | 0 | 90 |
| (a2) | (23-1-1) | 0 | 10 | 30 | 70 | 100 | 8 |
| (a3) | (33-1-1) | 0 | 0 | 0 | 0 | 0 | 2 |

### (Production of Compound (12-1-1) and Compound (23-1-2))

Into a 500 mL three-necked round bottom flask, 1.04 g of potassium hydroxide was put, and 83 g of tert-butanol and 125 g of 1,3-bis(trifluoromethyl) benzene were added. By stirring at room temperature, the potassium hydroxide was dissolved, and 250 g of compound (23-1-2) (FLUOROLINK (registered trademark) D10/H, manufactured by Solvay Solexis, Inc.) was added thereto, followed by stirring for 1 hour. At room temperature, 38.2 g of perfluoro(n-propyl vinyl ether) (CF₃ CF₂ CF₂—O—CF═CF₂) was added and further stirred for 24 hours. An aqueous hydrochloric acid solution was added for neutralization, and water was further added to carry out liquid separation treatment. After washing three times with water, an organic phase was recovered and concentrated by an evaporator, to obtain 288.0 g of a mixture comprising compound (12-1-1), compound (23-1-2) and compound (32-1-1).

CF₃—CF₂CF₂—O—CHFCF₂—O—CH₂—CF₂O{CF₂O)ₚ(CF₂CF₂O)_{q}}—CF₂CH₂—OH (12-1-1)

HO—CH₂—CF₂O{(CF₂O)ₚ(CF₂CF₂O)_{q}}—CF₂CH₂—OH (23-1-2)

CF₃—CF₂CF₂—O—CHFCF₂—O—CH₂—CF₂O{(CF₂O)ₚ(CF₂CF₂O)_{q}}—CF₂CH₂—O—CF₂CHF—O—CF₂CF₂—CF₃ (32-1-1)

Here, p/q=0.6, and p+q≈15.

The mixture was diluted with 144 g of AC-2000, and developed by silica gel column chromatography (developing solvents: AC-2000 and AE-3000) to fractionate the desired products. After the fractionation, the compound (12-1-1) and the compound (23-1-2) were mixed so that the mass ratio would be as shown in Table 2 to prepare the mixtures (p2-1) to (p2-5).

Mn of the compound (12-1-1) was 1,830, and Mn of the compound (23-1-2) was 1,570.

TABLE 2

| | | Mixture [mass ratio] | | | | |
|---|---|---|---|---|---|---|
| | | (p2-1) | (p2-2) | (p2-3) | (p2-4) | (p2-5) |
| (a1) | (12-1-1) | 100 | 90 | 70 | 30 | 0 |
| (a2) | (23-1-2) | 0 | 10 | 30 | 70 | 100 |

### [Compounds]

### (Compound (b))

(b-1): HOCH₂CH₂OC(═O)CH═CH₂ (2-hydroxyethyl acrylate, manufactured by Nippon Shokubai Co., Ltd.).

### (Polyisocyanate (c))

(c-1): Isocyanurate-modified hexamethylene diisocyanate represented by the formula (6-1) (s, t and u=6) (DURANATE (registered trademark) TKA-100, manufactured by Asahi Kasei Chemicals Corporation, cyclic trimer of hexamethylene diisocyanate, isocyanate group content: 21.8 mass %).

### (Photopolymerizable Compound)

(m-1): Dipentaerythritol hexaacrylate (corresponding to monomer (m11)),

(m-2): tris(acryloyloxyethyl) isocyanurate (corresponding to monomer (m12)).

### (Photopolymerization Initiator)

(i-1): 2-methyl-1-{4-(methylthio)phenyl}-2-morpholinopropan-1-one.

### (Organic Solvent)

(s-1): 2,2,3,3-tetrafluoropropanol,

(s-2): propylene glycol monomethyl ether.

### Ex. 1

### (Production of Fluorinated Compound)

Into a 50 mL two-necked flask equipped with a stirrer, 1.0 g of triisocyanate (c-1) and 6.0 g of AK-225 were put, and 7.5 mg of DBTDL and 0.3 mg of 2,6-di-tert-butyl-p-cresol were added. In a nitrogen atmosphere, over 1 hour with stirring at room temperature, a solution having 0.98 g of the mixture (p1-1) dissolved in 1.0 g of AK-225 was dropwise added, followed by stirring at room temperature for 12 hours. The mixture was warmed to 40° C., and 0.76 g of the compound (b-1) was added dropwise in 2 minutes and stirred for 12 hours. By the infrared absorption spectrum, it was confirmed that absorption of the isocyanate group disappeared completely, and the obtained reaction solution was concentrated by an evaporator to obtain the desired fluorinated compound.

### (Preparation of Hard Coat Layer-Forming Composition)

Into a 30 mL vial tube, 1 mg of the fluorinated compound, 94 mg of photopolymerizable compound (m-1), 94 mg of photopolymerizable compound (m-2), 11 mg of photopolymerization initiator (i-1), 18 mg of organic solvent (s-1) and 117 mg of organic solvent (s-2) were put and stirred for one hour at room temperature in a light-shielded state, to obtain a hard coat layer-forming composition.

### (Formation of Hard Coat Layer)

On the surface of a polyethylene terephthalate substrate, the hard coat layer-form ing composition was applied by bar coating, to form a coating film, which was dried for 1 minute on a hot plate at 50° C., to form a dried film on the surface of the substrate. Using a high pressure mercury lamp, UV was radiated (light amount: 300 mJ/cm², accumulated energy amount of UV with a wavelength of 365 nm), to form a hard coat layer having a thickness of 5 μm on the surface of the substrate.

Mn of the fluorinated compound, and the evaluation results of the hard coat layer-forming composition and the hard coat layer, are shown in Table 3.

### Ex. 2 to 6

Except that the mixture (p1-1) was changed to the mixture (p1-2) to (p1-6), in the same manner as in Ex. 1, a fluorinated compound was produced, a hard coat layer-form ing composition was prepared, and a hard coat layer was formed. Mn of the fluorinated compound, and the evaluation results of the hard coat layer-forming composition and the hard coat layer, are shown in Table 3.

TABLE 3

| | Ex. 1 | Ex. 2 | Ex. 3 | Ex. 4 | Ex. 5 | Ex. 6 |
|---|---|---|---|---|---|---|
| Mixture | (p1-1) | (p1-2) | (p1-3) | (p1-4) | (p1-5) | (p1-6) |
| (a1):(a2):(a3) | 100:0:0 | 90:10:0 | 70:30:0 | 30:70:0 | 0:100:0 | 90:8:2 |
| [mass ratio] | | | | | | |
| Mn of | 1,500 | 1,700 | 3,000 | 9,000 | * | 1,650 |
| fluorinated | | | | | | |
| compound | | | | | | |
| Compatibility | ◯ | ◯ | ◯ | X | * | ◯ |
| Storage | ◯ | ◯ | ◯ | ◯ | ◯ | ◯ |
| stability | | | | | | |
| Appearance of | ◯ | ◯ | ◯ | ◯ | ◯ | ◯ |
| hard coat layer | | | | | | |
| Fingerprint | ◯ | ◯ | ◯ | X | — | ◯ |
| stain | | | | | | |
| removability | | | | | | |
| Oily ink | ◯ | ◯ | ◯ | X | — | ◯ |
| repellency | | | | | | |
| Abrasion | X | ◯ | ◯ | X | — | ◯ |
| resistance of | | | | | | |
| antifouling | | | | | | |
| properties | | | | | | |
| Pencil hardness | 2H | 2H | 2H | 2H | 2H | 2H |

* Became insoluble during production and impossible to evaluate

### Ex. 7 to 11

Except that the mixture (p1-1) was changed to the mixture (p2-1) to (p2-5), in the same manner as in Ex. 1, a fluorinated compound was produced, a hard coat layer-forming composition was prepared, and a hard coat layer was formed. Mn of the fluorinated compound, and the evaluation results of the hard coat layer-forming composition and the hard coat layer are shown in Table 4.

TABLE 4

| | Ex. 7 | Ex. 8 | Ex. 9 | Ex. 10 | Ex. 11 |
|---|---|---|---|---|---|
| Mixture | (p2-1) | (p2-2) | (p2-3) | (p2-4) | (p2-5) |
| (a1):(a2) [mass ratio] | 100:0 | 90:10 | 70:30 | 30:70 | 0:100 |
| Mn of fluorinated | 1,300 | 1,500 | 2,600 | 8,000 | * |
| compound | | | | | |
| Compatibility | ◯ | ◯ | ◯ | X | * |
| Storage stability | ◯ | ◯ | ◯ | ◯ | ◯ |
| Appearance of hard coat | ◯ | ◯ | ◯ | ◯ | ◯ |
| layer | | | | | |
| Fingerprint stain | ◯ | ◯ | ◯ | X | — |
| removability | | | | | |
| Oily ink repellency | ◯ | ◯ | ◯ | X | — |
| Abrasion resistance of | Δ | ◯ | ◯ | X | — |
| antifouling properties | | | | | |
| Pencil hardness | 2H | 2H | 2H | 2H | 2H |

* Became insoluble during production and impossible to evaluate

The fluorinated compound in each of Ex. 2, 3, 6, 8 and 9, is one obtained by reacting the compound (a1), the compound (a2), the compound (b) and the polyisocyanate (c), wherein the proportion of the compound (a1) in the total of the compound (a1) and the compound (a2) is from 99.9 to 60 mass %, whereby the hard coat layer is excellent in antifouling properties and abrasion resistance of the antifouling properties.

In the fluorinated compound in each of Ex. 1 and 7, the proportion of the compound (a1) is 100 mass %, and the proportion of the compound (a2) is 0 mass %, whereby abrasion resistance of the antifouling properties is slightly inferior.

In the fluorinated compound in each of Ex. 4 and 10, the proportion of the compound (a1) is less than 60 mass %, and the proportion of the compound (a2) is more than 40 mass %, whereby compatibility is poor. Further, the antifouling properties are poor.

In the fluorinated compound in each of Ex. 5 and 11, the proportion of the compound (a1) is 0 mass %, and the proportion of the compound (a2) is 100 mass %, whereby insolubles were formed at the time of the production of the fluorinated corn pound.

### INDUSTRIAL APPLICABILITY

The fluorinated compound of the present invention is useful to impart excellent antifouling properties and abrasion resistance of the antifouling properties to an object (such as a hard coat layer). Further, it is useful in an application to impart antifouling properties and abrasion resistance of the antifouling properties to a molded product, by mixing it with a resin material, as a release agent for a mold, to prevent oil leakage for e.g. bearings, to prevent adhesion of a process solution at the time of processing an electronic component, etc., or to prevent moisture for a workpiece.

What is claimed is:

1. A fluorinated compound which is a reaction product of
a compound (a1) having a poly(oxyperfluoroalkylene) chain and one active hydrogen-containing group,
a compound (a2) having a poly(oxyperfluoroalkylene) chain and two active hydrogen-containing groups,
a compound (b) having a polymerizable carbon-carbon double bond and an active hydrogen-containing group, and
a polyisocyanate (c),
wherein the proportion of the portion derived from the compound (a1) to the total (100 mass %) of the portion derived from the compound (a1) and the portion derived from the compound (a2) is from 60 to 99.9 mass %.

2. The fluorinated compound according to claim 1, wherein the number average molecular weight of the compound (a1) is from 1,000 to 6,000, and the number average molecular weight of the compound (a2) is from 1,000 to 6,000.

3. The fluorinated compound according to claim 1, wherein the compound (a1) is a compound represented by the following formula (1), and the compound (a2) is a compound represented by the following formula (2),
D¹-(Cₘ₁F₂ₘ₁O)ₙ₁-E¹ (1)
wherein D¹ is D^{1 1}-R^{f 1}—O—CH₂— or D^{1 2}-O—,
D¹¹ is CF₃— or CF₃—O—,
R^{f1} is a C₁₋₂₀ fluoroalkylene group, a C₂₋₂₀ fluoroalkylene group having an etheric oxygen atom between carbon-carbon atoms, a C₁₋₂₀ alkylene group or a C₂₋₂₀ alkylene group having an etheric oxygen atom between carbon-carbon atoms,
D¹² is a C₁₋₆ perfluoroalkyl group,
m1 is an integer of from 1 to 6,
n1 is an integer of from 2 to 200, (C_{m 1} F_{2 m 1} O)_{n 1} may be one composed of at least two types of Cₘ₁F₂ₘ₁O different in m1,
E¹ is a monovalent organic group having one hydroxy group,
E²¹-(Cₘ₂F₂ₘ₂O)ₙ₂-E²² (2)
wherein E²¹ and E²² are each independently a monovalent organic group having one hydroxy group,
m2 is an integer of from 1 to 6,
n2 is an integer of from 2 to 200, and (Cₘ₂F₂ₘ₂O)ₙ₂ may be one composed of at least two types of Cₘ₂F₂ₘ₂O different in m2.

4. The fluorinated compound according to claim 3, wherein each of said (C_{m 1} F_{2 m 1}O)_{n 1} and said (C_{m 2} F_{2 m 2}O)_{n 2} is {(CF₂O)_{n 1 1} (CF₂ CF₂ O)_{n 1 2}} (wherein n11 is an integer of at least 1, n12 is an integer of at least 1, n11+n12 is an integer of from 2 to 200, and the bonding order of n11 pieces of CF₂O and n12 pieces of CF₂CF₂O is not limited).

5. The fluorinated compound according to claim 3, wherein D^{1 1}-R^{f 1}—O—CH₂— is R^{F 2}—O—CHFCF₂—O—CH₂— (wherein R^{F2} is a C₁₋₆ perfluoroalkyl group terminated with CF₃).

6. The fluorinated compound according to claim 3, wherein the compound (a1) is a compound obtained by converting E²¹ or E²² in the compound (a2) to D¹.

7. A method for producing a fluorinated compound, characterized by reacting
a compound (a1) having a poly(oxyperfluoroalkylene) chain and one active hydrogen-containing group,
a compound (a2) having a poly(oxyperfluoroalkylene) chain and two active hydrogen-containing groups, in such an amount that the proportion to the total (100 mass %) with the compound (a1) would be from 0.1 to 40 mass %,
a compound (b) having a polymerizable carbon-carbon double bond and an active hydrogen-containing group, in such an amount that the proportion to the total (100 mass %) of the compound (a1) and the compound (a2) would be from 10 to 50 mass %, and
a polyisocyanate (c) in such a proportion that any isocyanate group of the polyisocyanate (c) would not remain.

8. The method according to claim 7, wherein the isocyanate (c) is reacted to a mixture of the compound (a1) and the compound (a2) to produce a reaction intermediate having isocyanate groups, and then the compound (b) is reacted to the reaction intermediate.

9. The method according to claim 8, wherein the compound (a1) is a compound obtained by converting one of the active hydrogen-containing groups of the compound (a2) to a group other than an active hydrogen-containing group, and the mixture of the compound (a1) and the compound (a2) is a mixture of the formed compound (a1) obtained by the conversion and the unconverted compound (a2).

10. A photocurable composition characterized by comprising
the fluorinated compound as defined in claim 1,
a photopolymerizable compound (excluding the fluorinated compound), and
a photopolymerization initiator.

11. A coating liquid characterized by comprising
the photocurable composition as defined in claim 10, and
a solvent.

12. A hard coat layer-forming composition made of the photocurable composition as defined in claim 10.

13. A hard coat layer-forming composition made of the coating liquid as defined in claim 11.

14. An article characterized by comprising
a substrate, and
a hard coat layer formed from the hard coat layer-forming composition as defined in claim 12.

15. An article characterized by comprising
a substrate, and
a hard coat layer formed from the hard coat layer-forming composition as defined in claim 13.
